(19) United States
(12) Patent Application Publication
(10) Pub. No.: US 2026/0081387 A1
(43) Pub. Date: Mar. 19, 2026

(54) FIRST CONNECTOR AND CONNECTOR ASSEMBLY WITH CONVENIENT OPERATION

(71) Applicant: LUXSHARE PRECISION INDUSTRY COMPANY LIMITED, Shenzhen (CN)

(72) Inventors: Zhong-Yuan LAI, Shenzhen (CN); Zheng-Guo SUN, Shenzhen (CN); Hai-Bin YANG, Shenzhen (CN)

(73) Assignee: LUXSHARE PRECISION INDUSTRY COMPANY LIMITED, Shenzhen (CN)

(21) Appl. No.: 19/324,380

(22) Filed: Sep. 10, 2025

(30) Foreign Application Priority Data
Sep. 14, 2024 (CN) 202411295834.X

(51) Int. Cl. H01R 13/6581; H01R 12/75

(52) U.S. Cl. CPC H01R 13/6581; H01R 12/75

(57) ABSTRACT

A first connector used for mating with a second connector, includes: an insulating housing extending along an axial direction; a shielding shell at least partially enclosing the insulating housing and being configured to hold a cable; and a number of conductive terminals being retained in the insulating housing and exposed out of the shielding shell. The shielding shell is able to drive the cable to rotate forward/reversely around the axial direction with respect to the insulating housing. The present disclosure further relates to a connector assembly includes the abovementioned first connector and the abovementioned second connector.

### CROSS-REFERENCE TO RELATED APPLICATION

This patent application claims priority of a Chinese present disclosure No. 202411295834.X, filed on Sep. 14, 2024 and titled “CABLE-END CONNECTOR AND CONNECTOR ASSEMBLY”, the entire content of which is incorporated herein by reference.

### TECHNICAL FIELD

The present disclosure relates to a first connector and a connector assembly, having convenient operation when the first connector is mated with a second connector of the connector assembly.

### BACKGROUND

A cable-end connector (or called a plug connector) is used to be mated with a board-end connector (or called a receptacle connector) and sometimes the peripheral position of the board-end connector/receptacle connector is relatively cramped, for example, the board-end connector/receptacle connector is located at the corner of a specific space and is close to other components. If a cable of the cable-end connector/plug connector extends from the cable-end connector/plug connector at a specific angle, it will interfere with the correct installation of the cable-end connector/plug connector on the board-end connector/receptacle connector, which causes inconvenience of personnel operation process.

### SUMMARY

Some embodiments of the present disclosure are to provide a first connector which is capable of being installed on a second connector of a connector assembly without obstruction.

In some embodiments, a first connector includes: an insulating housing extending along an axial direction; a shielding shell at least partially enclosing the insulating housing and being configured to hold a cable; and a number of conductive terminals being retained in the insulating housing and exposed out of the shielding shell. The shielding shell is able to drive the cable to rotate forward/reversely around the axial direction with respect to the insulating housing.

Some embodiments of the present disclosure are to provide a connector assembly, the first connector thereof and the second connector thereof are unobstructed mated with each other.

In some embodiments, a connector assembly includes a first connector and a second connector used for mating with the first connector. The first connector includes an insulating housing extending along an axial direction; a cable extending along a direction perpendicular to the axial direction, the cable having a number of core wires; a shielding shell at least partially enclosing the insulating housing and being configured to hold the cable; and a number of conductive terminals being retained in the insulating housing and exposed out of the shielding shell. The conductive terminals are electrically connected with the core wires in a one-to-one correspondence manner. The second connector includes a circuit board; an insulating body; a number of mating terminals being retained in the insulating body, an electrical connection being realizable between the conductive terminals and the mating terminals when the first connector is plugged in the second connector; and a mating shell being fixed with the circuit board and covering the insulating body. The shielding shell is able to drive the cable to rotate forward/reversely around the axial direction with respect to the insulating housing.

In some embodiments, a connector assembly includes a first connector and a second connector used for mating with the first connector. The first connector includes an insulating housing extending along a first axial direction; a cable extending along a direction perpendicular to the first axial direction, the cable having a number of core wires; a shielding shell at least partially enclosing the insulating housing and being configured to hold the cable; and a number of conductive terminals being retained in the insulating housing and exposed out of the shielding shell. The conductive terminals are electrically connected with the core wires in a one-to-one correspondence manner. The second connector includes a circuit board; an insulating body extending along a second axial direction consistent with the first axial direction; a number of mating terminals being retained in the insulating body, an electrical connection being realizable between the conductive terminals and the mating terminals when the first connector is plugged in the second connector; and a mating shell being fixed with the circuit board and covering the insulating body. The shielding shell is able to drive the cable to not only rotate forward/reversely around the first axial direction with respect to the insulating housing but also rotate forward/reversely around the second axial direction with respect to the insulating body.

### BRIEF DESCRIPTION OF DRAWINGS

FIG. 1 is a perspective view of a connector assembly in accordance with an embodiment of the present disclosure, in which a first connector and a second connector are positioned in assembled state;

FIG. 2 is another perspective view of the connector assembly, in which the first connector and the second connector are positioned in disassembled state;

FIG. 3 is a perspective, assembled view of the first connector in accordance with an embodiment of the present disclosure;

FIG. 4 is a first perspective, exploded view of the first connector in FIG. 3;

FIG. 5 is a second perspective, exploded view of the first connector in FIG. 3;

FIG. 6 is a top view of the first connector in FIG. 3;

FIG. 7 is a first cross-sectional view when taken along line A-A in FIG. 6;

FIG. 8 is a second cross-sectional view when taken along line B-B in FIG. 6;

FIG. 9 is a perspective, assembled view of the second connector;

FIG. 10 is a perspective, exploded view of the second connector in FIG. 9;

FIG. 11 is a top view of the connector assembly in FIG. 1; and

FIG. 12 is a third cross-sectional view when taken along line C-C in FIG. 11.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

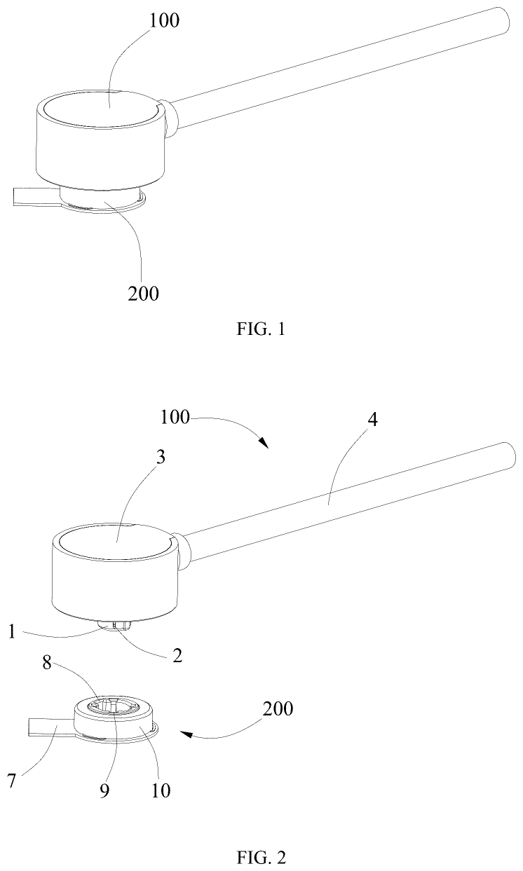

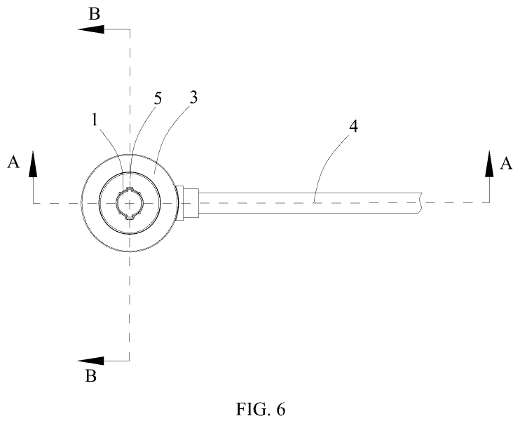

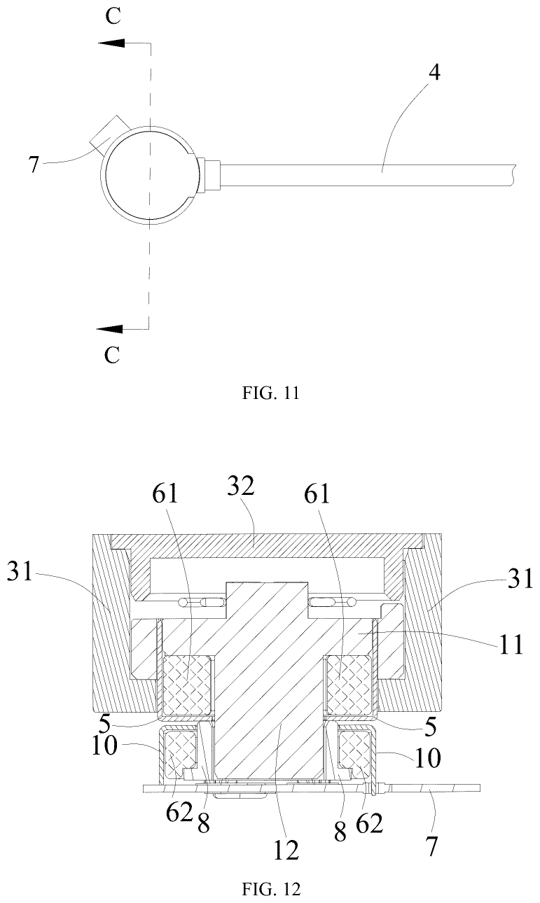

Referring to FIG. 1 to FIG. 12, the present disclosure discloses a first connector 100 for mating with a second connector 200, comprising: an insulating housing 1 extending along an axial direction, a plurality of conductive terminals 2, a shielding shell 3, and a cable 4 extending along a direction perpendicular to the axial direction. The cable 4 has a plurality of core wires (not labeled). The shielding shell 3 at least partially encloses the insulating housing 1 and holds the cable 4. The conductive terminals 2 are fixedly retained in the insulating housing 1 and exposed out of the shielding shell 3. The conductive terminals 2 are electrically connected with the core wires in a one-to-one correspondence manner. The shielding shell 3 is able to drive the cable 4 to rotate forward/reversely around the axial direction with respect to the insulating housing 1. In an embodiment, the first connector 100 is a cable-end connector (or called a plug connector) and the second connector 200 is a board-end connector (or called a receptacle connector).

Therefore, the first connector 100 of the present disclosure enables the cable 4 to avoid the relatively cramped peripheral position of the second connector 200, thereby does not interfere with the installation of the first connector 100 on the second connector 200, which facilitates to the smooth engagement between the first connector 100 and the second connector 200, ensures that the user places the cable 4 stretched outward in an orderly and normal manner in a limited space, and improves the use experience. The conductive terminals 2 and the core wires are positioned in a one-to-one correspondence manner and each conductive terminal 2 is fixed to the core wire by welding. Each core wire is designed with an additional wire length in the shielding shell 3 and the additional wire length of each core wire is a length margin reserved for rotation.

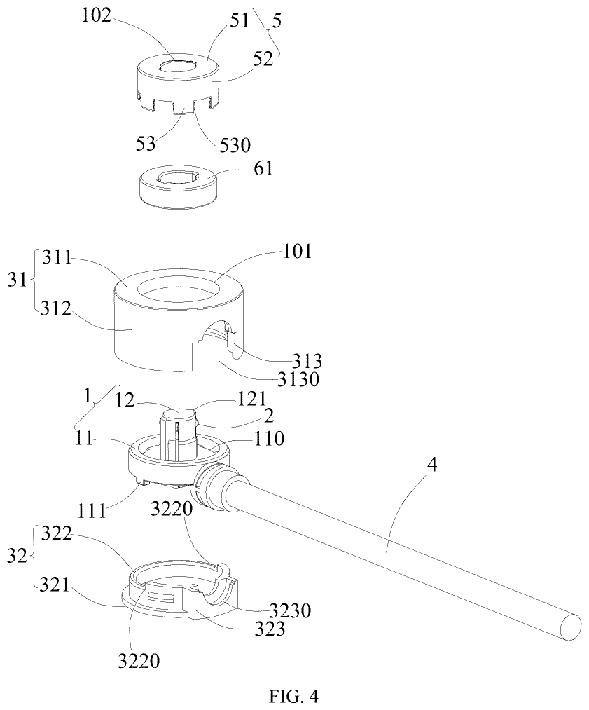

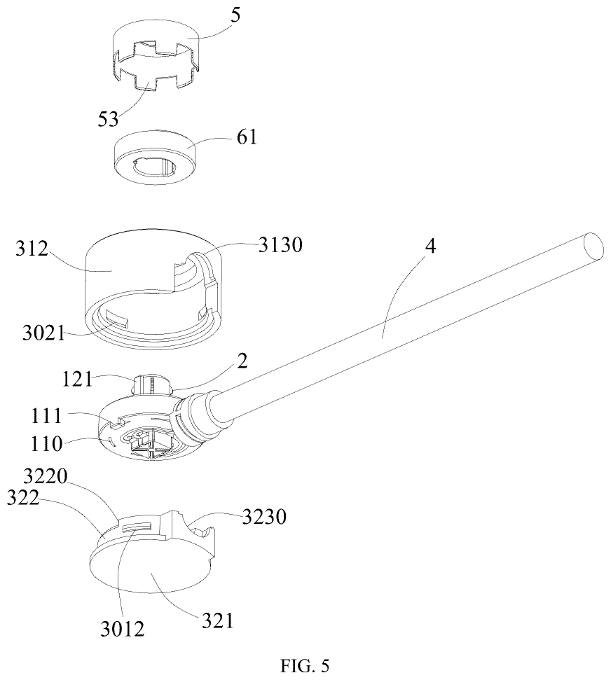

Referring to FIG. 4 and FIG. 5, the axial direction is also defined as a first axial direction or a top-bottom direction. The insulating housing 1 comprises a base portion 11 and a cylinder portion 12. The cylinder portion 12 protrudes and extends upward from the base portion 11 along the first axial direction. The shielding shell 3 comprises a first shielding shell 31 and a second shielding shell 32. The first shielding shell 31 and the second shielding shell 32 are respectively installed from upper and lower sides of the insulating housing 1 and are interlocked and fixed with each other. The first shielding shell 31 comprises a top wall 311 and a first annular sidewall 312. The second shielding shell 32 comprises a bottom wall 321 opposite to the top wall 311 and a second annular sidewall 322 buckled with the first annular sidewall 312. The first shielding shell 31 and the second shielding shell 32 both comprise annular sidewalls, so that the shielding shell 3 slimly and smoothly rotates forward/reversely around the first axial direction with respect to the insulating housing 1 because of no obstruction.

Furthermore, because the first shielding shell 31 and the second shielding shell 32 are interlocked and fixed together, the first shielding shell 31 and the second shielding shell 32 are composed of the shielding shell 3 and rotate together with respect to the insulating housing 1 as a whole. After the first shielding shell 31 and the second shielding shell 32 are respectively installed, interlocked and fixed on upper and lower sides of the insulating housing 1, the top wall 311 of the first shielding shell 31 is located on an upper side of the base portion 11, the bottom wall 321 of the second shielding shell 32 is located on the lower side of the base portion 11, and therefore, the first shielding shell 31 and the second shielding shell 32 are restrained on the insulating housing 1 in the first axial direction. Once the first shielding shell 31 and the second shielding shell 32 are buckled with each other, the shielding shell 3 has a rotatable connection state on the insulating housing 1 and will not be easily separated. The first shielding shell 31 and the second shielding shell 32 can be separated from upper and lower sides of the insulating housing 1 unless the locking effect between the first shielding shell 31 and the second shielding shell 32 is unraveled.

Referring to FIG. 4 and FIG. 5, the second annular sidewall 322 comprises two stepped portions 3220. The insulating housing 1 forms a boss portion 111 capable of being butted against the two stepped portions 3220 for restricting forward/reversely rotations. The boss portion 111 is butted against one of the stepped portions 3220 to stop a forward rotation of the shielding shell 3 with respect to the insulating housing 1. The boss portion 111 is butted against another stepped portion 3220 to stop a reversely rotation of the shielding shell 3 with respect to the insulating housing 1. Specifically, the present disclosure provides two stepped portions 3220 which are formed by partial excision of the second annular sidewall 322, and the arc length of that part of the excision accounts for about ½ of the entire second annular sidewall 322, and accordingly the rotatable range is limited, so as to facilitate normal rotation of the shielding shell 3 and homing to an original position of the shielding shell 3. When the first connector 100 of the present disclosure is assembled on the second connector 200 and during subsequent use of the first connector 100, the first connector 100 can be seamlessly connected and smoothly rotated in a range of 180 degrees. Therefore, the cable 4 of the first connector 100 that stretches out is guaranteed to be placed in an orderly and normal manner in a limited space by the user, and so a convenient use experience has been improved.

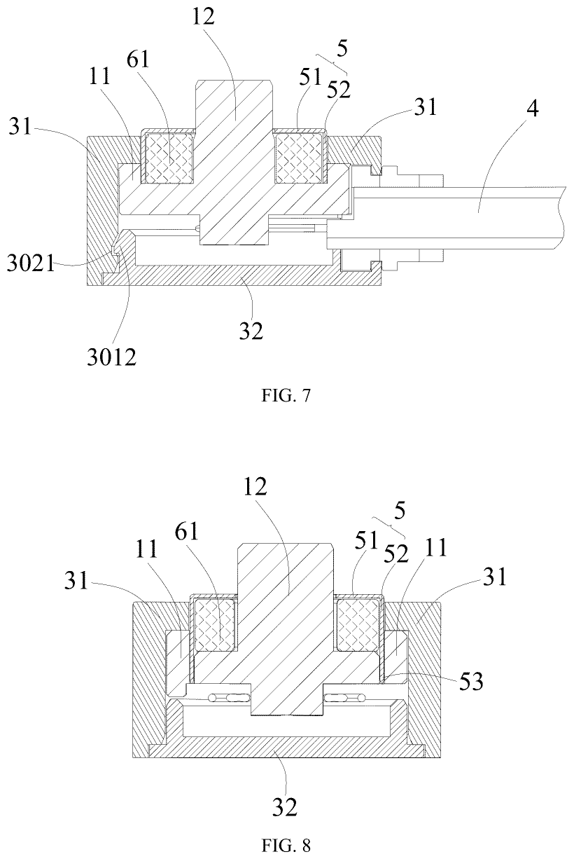

Referring to FIG. 4, FIG. 5 and FIG. 7, the first annular sidewall 312 comprises one of a clamping block 3012 and a clamping groove 3021, the second annular sidewall 322 comprises another one of the clamping block 3012 and the clamping groove 3021. Because the clamping block 3012 and the clamping groove 3021 are cooperated with each other, and therefore, the first shielding shell 31 and the second shielding shell 32 are firmly fastened together. It should be emphasized that when the first connector 100 is in use, the shielding shell 3 which is composed of the first shielding shell 31 and the second shielding shell 32 rotates together with respect to the insulating housing 1 as a whole, and there is no relative position rotation between the first shielding shell 31 and the second shielding shell 32.

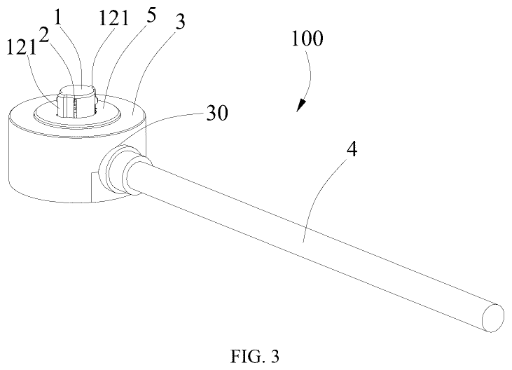

Referring to FIG. 3 to FIG. 5, the first annular sidewall 312 comprises a positioning portion 313 and the positioning portion 313 has a first half hole 3130 with an opening facing to the second shielding shell 32. The second annular sidewall 322 comprises a limiting portion 323 and the limiting portion 323 has a second half hole 3230 with an opening facing to the first shielding shell 31. The first half hole 3130 and the second half hole 3230 cooperate to form a circular hole 30, and the circular hole 30 is used for the cable 4 to penetrate therefrom inner to out. Because the first shielding shell 31 and the second shielding shell 32 are combined into the shielding shell 3, for one aspect, the cable 4 is actually clamped and limited by the positioning portion 313 and the limiting portion 323 of the shielding shell 3, and for another aspect, the cable 4 penetrates from the circular hole 30, and therefore, the cable 4 is naturally driven by the shielding shell 3 in the use process of the first connector 100. That is, the shielding shell 3 can drive the cable 4 to rotate forward/reversely around the first axial direction with respect to the insulating housing 1.

Referring to FIG. 3 to FIG. 8, the present disclosure discloses a first connector 100 further comprises a cover 5 and a first magnetic element 61. The cover 5 also comprises a top plate 51 and an annular side plate 52 extending and bending from the top plate 51, and wherein the top plate 51 and the annular side plate 52 are capable of contacting with the first magnetic element 61 for maintaining the first magnetic element 61. The effect of the first magnetic element 61 is that, it can form a matching automatic correction with the second magnetic element 62 in the second connector 200, which adopts the principle of heteropolar magnetic attraction and automatically guides and reliably fixes the contact conduction. The function of the cover 5 is that, when the first magnetic element 61 is limited in the limiting space which is defined by the shielding shell 3 and the insulating housing 1, the cover 5 covers the limiting space and prevents the first magnetic element 61 from falling out of the limiting space. Therefore, the cover 5 can be understood as a cover that prevents something from falling off.

Referring to FIG. 4, FIG. 5 and FIG. 8, the cover 5 comprises a plurality of clamping pins 53 extending downward from the annular side plate 52. Each clamping pin 53 comprises a plurality of barbs 530, the insulating housing 1 comprises a plurality of perforations 110, the clamping pins 53 are correspondingly extended into the perforations 110 and the clamping pins 53 are interfering with the inner wall surfaces of the perforations 110 by the barbs 530, and then the cover 5 is fixed with the insulating housing 1. In other words, the cover 5 is fixed with the insulating housing 1 as a whole just like the conductive terminals 2 are fixed with the insulating housing 1, both of the cover 5 and the conductive terminals 2 are immovable with respect to the insulating housing 1. Therefore, the cover 5 does not rotate with respect to the insulating housing 1, that is to say, in the forward/reversely rotation of the shielding shell 3 which rotates axially with respect to the insulating housing 1, and accordingly, there is relative motion between the cover 5 and the shielding shell 3. It is not difficult to understand that the cover 5 and the shielding shell 3 are not fixed with each other and so easily separated from each other.

Referring to FIG. 3, FIG. 4, FIG. 7, and FIG. 8, the bottom wall 321 of the shielding shell 3 is in the form of a non-opened plate and the top wall 311 of the shielding shell 3 has an annular plate shape with a first opening 101 in the middle thereof. The cover 5 is attached to the first shielding shell 31 to form the inner wall surface of the first opening 101, and the first shielding shell 31 and the second shielding shell 32 rotate together with respect to the cover 5. Specifically, the first magnetic element 61 is sleeved on the cylinder portion 12 and is abutted against the base portion 11, and both the top plate 51 and the annular side plate 52 are in contact with the first magnetic element 61, so that the first magnetic element 61 is kept between the insulating housing 1 and the cover 5 and located at a restricted state, preventing it from falling. Because the conductive terminals 2 are fixedly retained in the insulating housing 1 and exposed outside of the shielding shell 3 and the cover 5 is a cover that prevents the first magnetic element 61 from falling off, the cover 5 needs to have a second opening 102 corresponding to the first opening 101 along a top-bottom direction. The cylinder portion 12 passes through the first opening 101 and the second opening 102 so that the conductive terminal 2 can be exposed outside of the cylinder portion 12 and mate with the mating terminals 9 of the second connector 200.

Referring to FIG. 1 to FIG. 12, the present disclosure also relates to a connector assembly which comprises a first connector 100 and a second connector 200 as described above. The second connector 200 comprises a circuit board 7, an insulating body 8, a plurality of mating terminals 9 and a mating shell 10. The mating terminals 9 are fixedly retained in the insulating body 8. The mating shell 10 is fixed with the circuit board 7 and covers the insulating body 8. When the first connector 100 is plugged in the second connector 200, the conductive terminals 2 can realize an electrical connection with the mating terminals 9. The insulating body 8 has a second axial direction which is consistent with the first axial direction, and therefore, not only the first axial direction is called as the top-bottom direction but also the second axial direction is called as the top-bottom direction.

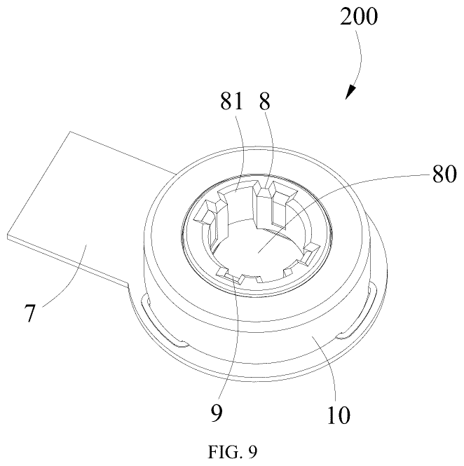

Referring to FIG. 9 to FIG. 12, the insulating body 8 defines a receiving space 80, the mating shell 10 has a third opening 103, and the third opening 103 corresponds to the receiving space 80 along the top-bottom direction. When the first connector 100 is plugged into the second connector 200, the conductive terminals 2 can realize electrical connection with the mating terminals 9 in the receiving space 80. That is, the cylinder portion 12 extends into the receiving space 80 to realize the electrical connection between the conductive terminals 2 and the mating terminals 9.

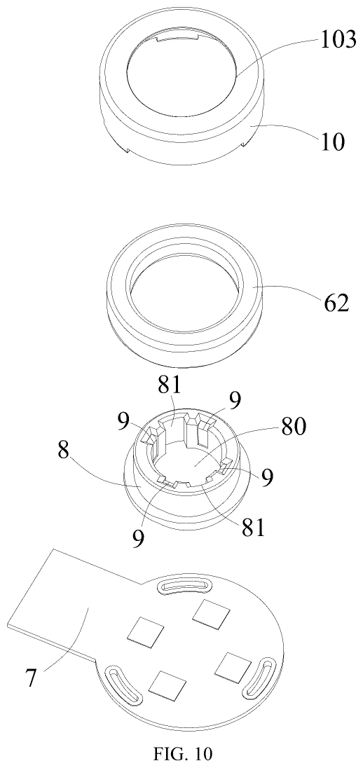

Referring to FIG. 10 and FIG. 12, the first connector 100 comprises a first magnetic element 61, the second connector 200 comprises a second magnetic element 62, and the second magnetic element 62 is capable of magnetically attracting the first magnetic element 61. As preceding mentioned, the first magnetic element 61 forms a matching automatic guide with the second magnetic element 62, adopts the principle of heteropolar magnetic attraction, automatically guides the first connector 100 and the second connector 200, and realizes reliable fixation and contact conduction between the conductive terminals 2 and the mating terminals 9.

Referring to FIG. 4 and FIG. 10, the insulating housing 1 comprises a first foolproof structure 121 and the insulating body 8 comprises a second foolproof structure 81. Specifically, the first foolproof structure 121 is a foolproof rib formed on the cylinder portion 12 of the insulating housing 1 and the second foolproof structure 81 is a foolproof groove formed on the insulating body 8. In other embodiments, the positions of the foolproof rib and the foolproof groove on either the insulating housing 1 or the insulating body 8 are also interchangeable. When the first foolproof structure 121 is got from one of the foolproof rib and the foolproof groove, the second foolproof structure 81 is accordingly determined as a rest one of the foolproof rib and the foolproof groove, and therefore the first foolproof structure 121 is cooperative with the second foolproof structure 81. In summary, the first foolproof structure 121 can cooperate with the second foolproof structure 81 to play the role of foolproof, which ensures the correct engagement between the conductive terminal 2 and the mating terminals 9.

Summarily, the shielding shell 3 is able to drive the cable 4 to rotate forward/reversely around the (first/second) axial direction with respect to both the insulating housing 1 and the insulating body 8 for adjusting an angle of the cable 4. Firstly, the present disclosure enables the cable 4 to avoid the relatively cramped peripheral position of the second connector 200, so that the installation of the first connector 100 on the second connector 200 will not be interfered, facilitates smooth engagement of the first connector 100 on the second connector 200, and ensures that the user places the cable 4 stretched outward in an orderly and normal manner in a limited space, and improves the user's experience; Secondly, the present disclosure further forms a matching automatic guide through the first magnetic element 61 and the second magnetic element 62, adopts the principle of heteropolar magnetic attraction, automatically guides the first connector 100 and the second connector 200, realizes reliable fixation and contact conduction between the conductive terminal 2 and the mating terminals 9; Thirdly, the present disclosure further adopts the design of difference side edge foolproof structure to ensure the correct docking between the conductive terminals 2 and the mating terminals 9; Finally, when the present disclosure of the first connector 100 and the second connector 200 in a match state, by adopting the contact surfaces of “metal and metal” formed between the shielding shell 3 and the mating shell 10, the electric connection process is guaranteed to the greatest extent, can withstand high-intensity impact and is not damaged.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A first connector comprising:
an insulating housing extending along an axial direction;
a shielding shell at least partially enclosing the insulating housing and being configured to hold a cable; and
a plurality of conductive terminals being retained in the insulating housing and exposed out of the shielding shell;
wherein the shielding shell is able to drive the cable to rotate forward/reversely around the axial direction with respect to the insulating housing.

2. The first connector according to claim 1, wherein the axial direction is also defined as a top-bottom direction, the shielding shell comprises a first shielding shell and a second shielding shell, the first shielding shell and the second shielding shell are respectively installed from upper and lower sides of the insulating housing and are interlocked and fixed with each other; and wherein the first shielding shell comprises a top wall and a first annular sidewall and accordingly the second shielding shell comprises a bottom wall opposite to the top wall and a second annular sidewall buckled with the first annular sidewall.

3. The first connector according to claim 2, wherein the second annular sidewall comprises two stepped portions and the insulating housing forms a boss portion capable of being butted against the two stepped portions for restricting forward/reversely rotations, such that the boss portion is butted against one of the stepped portions to stop a forward rotation of the shielding shell with respect to the insulating housing and the boss portion is butted against another stepped portion to stop a reversely rotation of the shielding shell with respect to the insulating housing.

4. The first connector according to claim 2, wherein the first annular sidewall comprises one of a clamping block and a clamping groove, the second annular sidewall comprises another one of the clamping block and the clamping groove, the clamping block and the clamping groove are cooperated with each other, and therefore, the first shielding shell and the second shielding shell are firmly fastened together.

5. The first connector according to claim 2, further comprising the cable, the cable extending along a direction perpendicular to the axial direction, the cable having a plurality of core wires, and the conductive terminals being electrically connected with the core wires in a one-to-one correspondence manner; wherein the first annular sidewall comprises a positioning portion and the positioning portion has a first half hole with an opening facing to the second shielding shell, the second annular sidewall comprises a limiting portion and the limiting portion has a second half hole with an opening facing to the first shielding shell, and wherein the first half hole and the second half hole cooperate to form a circular hole which is used for the cable penetrating therefrom inner to out.

6. The first connector according to claim 1, further comprising a cover and a first magnetic element, wherein the cover comprises a top plate and an annular side plate extending and bending from the top plate, and wherein the top plate and the annular side plate are capable of contacting with the first magnetic element for maintaining the first magnetic element.

7. The first connector according to claim 6, wherein the cover comprises a plurality of clamping pins extending downward from the annular side plate, each clamping pin comprises a plurality of barbs, the insulating housing comprises a plurality of perforations, the clamping pins are correspondingly extended into the perforations, the clamping pins are interfering with the inner wall surfaces of the perforations by the barbs, the cover is fixed with the insulating housing, and the first magnetic element is kept between the insulating housing and the cover and located at a restricted state.

8. A connector assembly, comprising:
a first connector, comprising:
an insulating housing extending along an axial direction;
a cable extending along a direction perpendicular to the axial direction, the cable having a plurality of core wires;
a shielding shell at least partially enclosing the insulating housing and being configured to hold the cable; and
a plurality of conductive terminals being retained in the insulating housing and exposed out of the shielding shell, the conductive terminals being electrically connected with the core wires in a one-to-one correspondence manner; and
a second connector configured to mate with the first connector, comprising:
a circuit board;
an insulating body;
a plurality of mating terminals being retained in the insulating body, an electrical connection being realizable between the conductive terminals and the mating terminals when the first connector is plugged in the second connector; and
a mating shell being fixed with the circuit board and covering the insulating body; wherein the shielding shell is able to drive the cable to rotate forward/reversely around the axial direction with respect to the insulating housing.

9. The connector assembly according to claim 8, wherein the first connector comprises a first magnetic element, the second connector comprises a second magnetic element, and the second magnetic element is capable of magnetically attracting the first magnetic element.

10. The connector assembly according to claim 8, wherein the insulating housing comprises a first foolproof structure and the insulating body comprises a second foolproof structure, the first foolproof structure is got from one of the foolproof rib and the foolproof groove and the second foolproof structure is accordingly determined as a rest one of the foolproof rib and the foolproof groove, therefore the first foolproof structure is cooperative with the second foolproof structure.

11. A connector assembly, comprising:
a first connector, comprising:
an insulating housing extending along a first axial direction;
a cable extending along a direction perpendicular to the first axial direction, the cable having a plurality of core wires;
a shielding shell at least partially enclosing the insulating housing and being configured to hold the cable; and
a plurality of conductive terminals being retained in the insulating housing and exposed out of the shielding shell, the conductive terminals being electrically connected with the core wires in a one-to-one correspondence manner; and
a second connector configured to mate with the first connector, comprising:
a circuit board;
an insulating body extending along a second axial direction consistent with the first axial direction;
a plurality of mating terminals being retained in the insulating body, an electrical connection being realizable between the conductive terminals and the mating terminals when the first connector is plugged in the second connector; and
a mating shell being fixed with the circuit board and covering the insulating body; wherein the shielding shell is able to drive the cable to not only rotate forward/reversely around the first axial direction with respect to the insulating housing but also rotate forward/reversely around the second axial direction with respect to the insulating body.

12. The connector assembly according to claim 11, wherein not only the first axial direction is defined as a top-bottom direction but also the second axial direction is defined as the top-bottom direction; the shielding shell comprises a first shielding shell and a second shielding shell, the first shielding shell and the second shielding shell are respectively installed from upper and lower sides of the insulating housing and are interlocked and fixed with each other; and wherein the first shielding shell comprises a top wall and a first annular sidewall and accordingly the second shielding shell comprises a bottom wall opposite to the top wall and a second annular sidewall buckled with the first annular sidewall.

13. The connector assembly according to claim 12, wherein the second annular sidewall comprises two stepped portions and the insulating housing forms a boss portion capable of being butted against the two stepped portions for restricting forward/reversely rotations, such that the boss portion is butted against one of the stepped portions to stop a forward rotation of the shielding shell with respect to the insulating housing and the boss portion is butted against another stepped portion to stop a reversely rotation of the shielding shell with respect to the insulating housing.

14. The connector assembly according to claim 12, wherein the first annular sidewall comprises one of a clamping block and a clamping groove, the second annular sidewall comprises another one of the clamping block and the clamping groove, the clamping block and the clamping groove are cooperated with each other, and therefore, the first shielding shell and the second shielding shell are firmly fastened together.

15. The connector assembly according to claim 12, wherein the first annular sidewall comprises a positioning portion and the positioning portion has a first half hole with an opening facing to the second shielding shell, the second annular sidewall comprises a limiting portion and the limiting portion has a second half hole with an opening facing to the first shielding shell, and wherein the first half hole and the second half hole cooperate to form a circular hole which is used for the cable penetrating therefrom inner to out.

16. The connector assembly according to claim 11, further comprising a cover and a first magnetic element, wherein the cover comprises a top plate and an annular side plate extending and bending from the top plate, and wherein the top plate and the annular side plate are capable of contacting with the first magnetic element for maintaining the first magnetic element.

17. The connector assembly according to claim 16, wherein the cover comprises a plurality of clamping pins extending downward from the annular side plate, each clamping pin comprises a plurality of barbs, the insulating housing comprises a plurality of perforations, the clamping pins are correspondingly extended into the perforations, the clamping pins are interfering with the inner wall surfaces of the perforations by the barbs, the cover is fixed with the insulating housing, and the first magnetic element is kept between the insulating housing and the cover and located at a restricted state.

18. The connector assembly according to claim 11, wherein the first connector comprises a first magnetic element, the second connector comprises a second magnetic element, and the second magnetic element is capable of magnetically attracting the first magnetic element.

19. The connector assembly according to claim 11, wherein the insulating housing comprises a first foolproof structure and the insulating body comprises a second foolproof structure, the first foolproof structure is got from one of the foolproof rib and the foolproof groove and the second foolproof structure is accordingly determined as a rest one of the foolproof rib and the foolproof groove, therefore the first foolproof structure is cooperative with the second foolproof structure.

20. The connector assembly according to claim 11, wherein the insulating housing comprises a base portion and a cylinder portion, the insulating body defines a receiving space, and the cylinder portion extends from the base portion into the receiving space along both the first axial direction and the second axial direction, two of which are both consistent with a top-bottom direction, to realize the electrical connection between the conductive terminals and the mating terminals.
